(19) United States
(12) Patent Application Publication
(10) Pub. No.: US 2005/0021603 A1
(43) Pub. Date: Jan. 27, 2005

(54) Server

(76) Inventors: Yasushi Yokomitsu, Chikushino-shi (JP); Tomohiro Ohshima, Fukuoka-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/760,552

(22) Filed: Jan. 21, 2004

(30) Foreign Application Priority Data
Jan. 21, 2003 (JP) P.2003-12241

(51) Int. Cl. G06F 15/16

(52) U.S. Cl. 709/203

(57) ABSTRACT

The invention aims at providing a server which manages address information for servers subordinate to a port-forwarding relay device (router) thus allowing an access from a wide area network. A representative server issues a request to assign a default port number to a router. The port management unit of the representative server registered to a default port number acquires the IP address of the router (wide area network address) and port mapping information (port number information on other equipment) from the router and retains the information acquired. In case it is determined that an access from the wide area network is first directed to a representative server, the representative server displays in a list the port number information on the accessing terminal in response to an access from the wide area network. This allows an external user to readily access desired equipment. The representative server periodically makes a port mapping information to the router and updates the information.

### BACKGROUND OF THE INVENTION

1. Field of the Invention

This invention relates to a server connected to a relay device such as a router and in particular to a server which can be assigned a port number for port forwarding.

2. Description of the Related Art

In recent years, ADSL and CATV technologies for continuous connections to a wide area network such as the Internet have been in widespread use, with broadband routers becoming widely available. FIG. 15 is a block diagram of a router having a related art port forwarding capability. FIG. 16 is an explanatory drawing of a related art port forwarding setting table.

In FIGS. 15 and 16, a numeral 101 represents the Internet, 102 a router equipped with a plurality of LAN ports, 103 Server A having a port number “80” and a local IP address “192.168.0.253” and 104 Server B having a port number “81” and a local IP address “192.168.0.254”. In this way, the router 102 generally connects the Internet 101 to its WAN port and a plurality of user devices such as Server A 103 and Server B 104 to its LAN ports.

The current IP protocol IPv4 has an insufficient number of absolute global IP addresses so that it uses the NAT (Network Address Translation) feature and the port forwarding feature (static IP masquerade feature) to offset the shortage of global IP addresses. The NAT feature converts the local address of a LAN device accessing the Internet 101 to a global IP aggress of the WAN port of the router 102.

In case an access is made from a specific device connected to a LAN port from the Internet 101, the port forwarding feature (static IP masquerade feature) of the router 102 is used. In the actual process, a port number and an IP address conversion table must be previously set to the router 102 as shown in FIG. 16. In an access from the Internet 101, the global IP address and the port number of the router 102 are specified. The router 102, accepting this access, converts the global IP address to a local IP address as per the preset conversion table. This conversion allows an access from the Internet 101 to a device having a local IP address in a LAN.

For example, in case an access is made to Server A 103 and Server B 104 connected to LAN ports of the router 102 shown in FIG. 15, the aforementioned port forwarding setting is previously performed on the router 102. In case an access is made from the Internet 101 to Server A 103, http://serverA.server.net:81/” is to be specified. In case an access is made from the Internet 101 to Server B 104, http://serverB.server.net:80/” is to be specified. This allows a DNS server on the Internet 101 to perform conversion to the global IP address of the route 102 thus providing an access to the router. In accordance with the conversion table, the router forwards an access to ports “80” and “81” to the local IP address “192.168.0.253” and the local IP address “192.168.0.254” thus allowing an access to Server A 103 and Server B 104. To access Server A 103 and Server B 104 by using the port forwarding feature, port numbers must be assigned to the servers so that the numbers will not be duplicate.

According to the aforementioned related art port forwarding feature (static IP masquerade feature), port numbers are automatically assigned to devices in the LAN so that the user in the LAN access a device without knowing its port number. By contract, the user on the Internet must know the port number of the device in the LAN in order to access the device. Further, in case a port number is changed due to LAN system reconfiguration, the change must be supported manually.

The UPnP forum specifies a standard for dynamic setting of port forwarding (port mapping). In this standard, a subordinate terminal makes an inquiry to a router about whether its corresponding port is available and the router registers the terminal in case the port is available. In case it is unavailable, the terminal makes an inquiry about whether its corresponding port is available until the port is determined. In the process, the router automatically sets the port number on the Internet. This approach has a problem that a port number is automatically selected and the user on the Internet does not know which port number is assumed to which terminal.

The UPnP standard is on the URL: http://www.upnp.org/standardizeddcps/default.asp as retrieved on the Internet on Nov. 29, 2002.

### SUMMARY OF THE INVENTION

In view of the related art problems, the invention aims at providing a server which manages address information for servers subordinate to a port-forwarding relay device thus allowing an access from a wide area network.

A first aspect of the invention accomplished to solve the problems is a server subordinate to a relay device having a port forwarding feature, the server comprising port management means which requests a relay device to assign a predetermined port number for a representative server and which is assigned a port number, wherein the port management means acquires the wide area network address of the relay device and port mapping information in case the port management means is registered to the predetermined port address and where in the port management means provides the address information on other servers in response to an access from a wide area network. When the port management means is assigned a predetermined port number, the server establishes itself as a representative server and acquires the global IP address of the relay device and port mapping information and manages the address port information on other servers thus allowing an access from the wide area network.

The port management means requests port mapping information from the relay device on a regular basis so that the representative server can hold the up-to-date port mapping information.

According to a second aspect of the invention , a server assigned a predetermined port number as a representative server, makes an inquiry about port mapping information and retains the port numbers transmitted from the image servers in order to manage the address/port information on the other servers thus allowing an access from the wide area network.

According to a third aspect of the invention, port management means makes an inquiry via broadcast, multicast or unicast to all servers. This allows a batch request of port mapping information.

According to a fourth aspect of the invention, in case the server is assigned a predetermined port number, the port management means requests use registration information from the relay device and fetches port mapping information from the use registration information obtained. The representative server acquires use registration information stored in the relay device and fetches port mapping information therefrom thus facilitating acquisition of information.

According to a fifth aspect of the invention, in case a predetermined port number is assigned to another server, the port management means notifies the other server of its port number assigned. In case a representative server has been registered when an attempt is made to assign a predetermined port number in order to establish itself as a representative server, the port number is communicated to the representative server so that the address information is managed by the representative server thus allowing an access from the wide area network.

According to a sixth aspect of the invention, a server comprises a web page generating section and generates a web page where address information on other servers is attached in a linkable fashion. On the web page of the representative server is posted address information on other servers managed by the representative server in a linkable fashion, thus allowing an access to other servers from the wide area network.

According to a seventh aspect of the invention, port management means adds host names for identification to other servers and posts the host names in the address information. On the web page of the representative server is posted address information including the host names of other servers managed by the representative server in a linkable fashion, thus allowing an access to other servers from the wide area network.

According to an eighth aspect of the invention, when the server has detected that a server registered to a predetermined port number withdrew from the LAN, another server transmits an identification message to register itself to the predetermined port. When the representative server withdraws from a LAN, each server issues an identification message in order to avoid contention between servers. This smoothly rotates the position of a representative server in accordance with the priority order.

According to a ninth aspect of the invention, after detection of withdrawal, other servers transmit identification messages after a random time has elapsed. Other servers transmit identification messages respectively after a random time has elapsed. In case two or more servers issue identification message within a certain time after that, these servers transmit identification messages respectively after a random time has elapsed until a sole server identifies itself, which avoids contention of a next representative server. In case a plurality of servers identifies themselves, all servers or only the identifying servers alone transmit next identification messages.

According to a tenth aspect of the invention, after detection of withdrawal, another server is registered to the predetermined port based on the mapped port numbers. This rotates the representative server based on the order of predetermined port numbers, thus smoothly rotating the position of a representative server.

According to an eleventh aspect of the invention, after detection of withdrawal, other servers respectively transmit identification messages after a time calculated from each server-specific value has elapsed and a sole server determined based on a predetermined determination rule becomes a representative server and is registered to the predetermined port. The representative server is rotated by using a server-specific value and based on a predetermined rule, thus smoothly rotating the position of a representative server.

According to a twelfth aspect of the invention, a server registered to a predetermined port number communicates as a single unit a withdrawal notice message to the servers in the LAN to notify that the server has withdrawn from the LAN. The representative server simultaneously transmits a withdrawal notice message to the servers so that each server can identify itself without fail thus smoothly rotating the position of a representative server.

According to a thirteenth aspect of the invention, a server in the LAN detects that there is no inquiry about port mapping information from the server registered to a predetermined port number to detect that the server has withdrawn from the LAN. It is possible to readily detect that the server has withdrawn from the LAN in the inquiry sequence without any special procedure.

According to a fourteenth aspect of the invention, all servers in the LAN make inquiries to the server registered to a predetermined port number about its presence and receiving no response, detects the server has withdrawn from the LAN. The representative server receives an inquiry about its presence. It is thus possible to readily detect that the server has withdrawn from the LAN.

According to a fifteenth aspect of the invention, in case a server is connected to a second network of a relay device which transfers data from its first network to its second network in accordance with a destination port number, a server of the invention requests the relay device to assign a predetermined port number out of the port numbers used for data transfer, and determining that the predetermined port number has been assigned, acquires the port assignment information on other servers from the relay device to generate display information including the port assignment information and transmit the display information in response to an access from the first network via the relay device. This makes it possible to provide the port assignment information on other servers to a terminal which accessed the address of the first relay device with the predetermined port number added from the first network.

### BRIEF DESCRIPTION OF THE DRAWINGS

FIG. 1 is a block diagram of a network system which accesses the servers subordinate to a router in Embodiment 1 of the invention;

FIG. 2 is a block diagram of a server in Embodiment 1 of the invention;

FIG. 3 is a flowchart of setting the server ports in Embodiment 1 of the invention;

FIG. 4 is a flowchart of acquisition of port mapping information by a representative server in Embodiment 1 of the invention;

FIG. 5 explains the sequence of acquisition of port mapping information by a representative server in Embodiment 1 of the invention;

FIG. 6 explains the operation screen for a representative server in Embodiment 1 of the invention;

FIG. 7 is a flowchart of generation of HTML information displayed on a representative server in Embodiment 1 of the invention;

FIG. 8A is a first port forwarding table diagram in Embodiment 1 of the invention;

FIG. 8B is a second port forwarding table diagram in Embodiment 1 of the invention;

FIG. 9 is a flowchart of acquisition of port mapping information by a representative server in Embodiment 2 of the invention;

FIG. 10 explains the sequence of acquisition of port mapping information by a representative server in Embodiment 2 of the invention;

FIG. 11 is a flowchart of rotation of a representative server in Embodiment 4 of the invention;

FIG. 12 explains a first rotation sequence of a representative server in Embodiment 4 of the invention;

FIG. 13 explains a second rotation sequence of a representative server in Embodiment 4 of the invention;

FIG. 14 explains a third rotation sequence of a representative server in Embodiment 4 of the invention;

FIG. 15 is a block diagram of a router having the host name forwarding feature; and

FIG. 16 explains a related art port forwarding setting table.

### DESCRIPTION OF THE PREFERRED EMBODIMENTS

Embodiments of the invention are described below referring to attached drawings.

### Embodiment 1

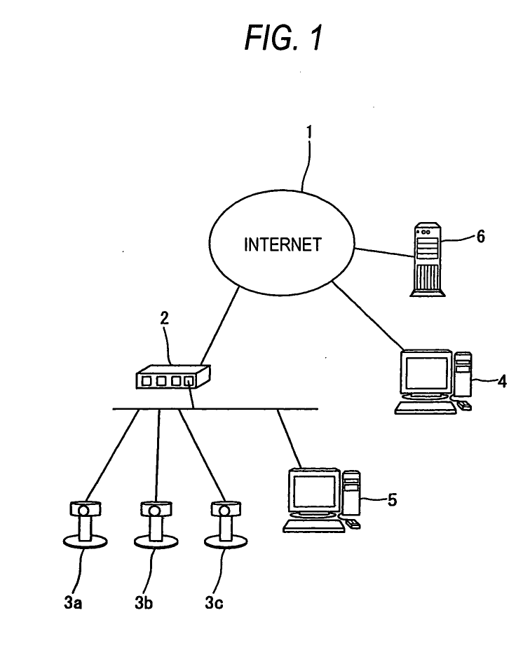

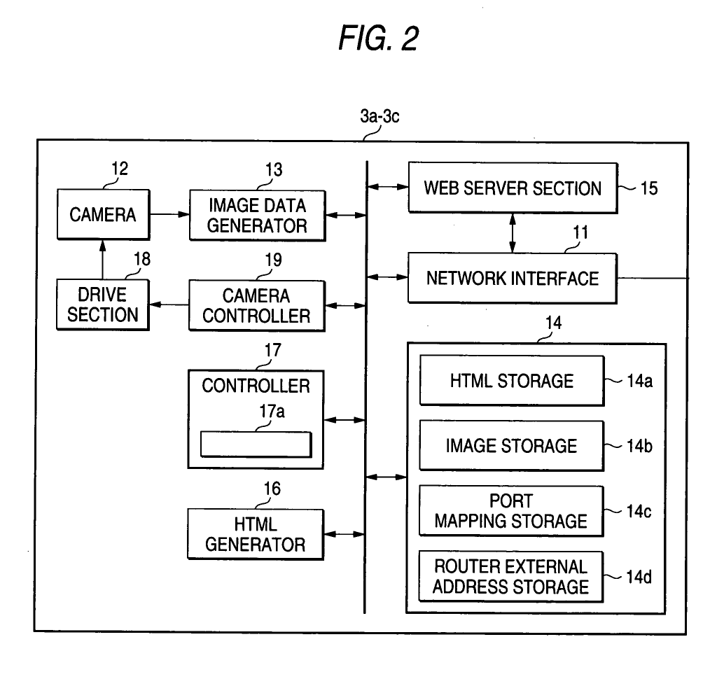

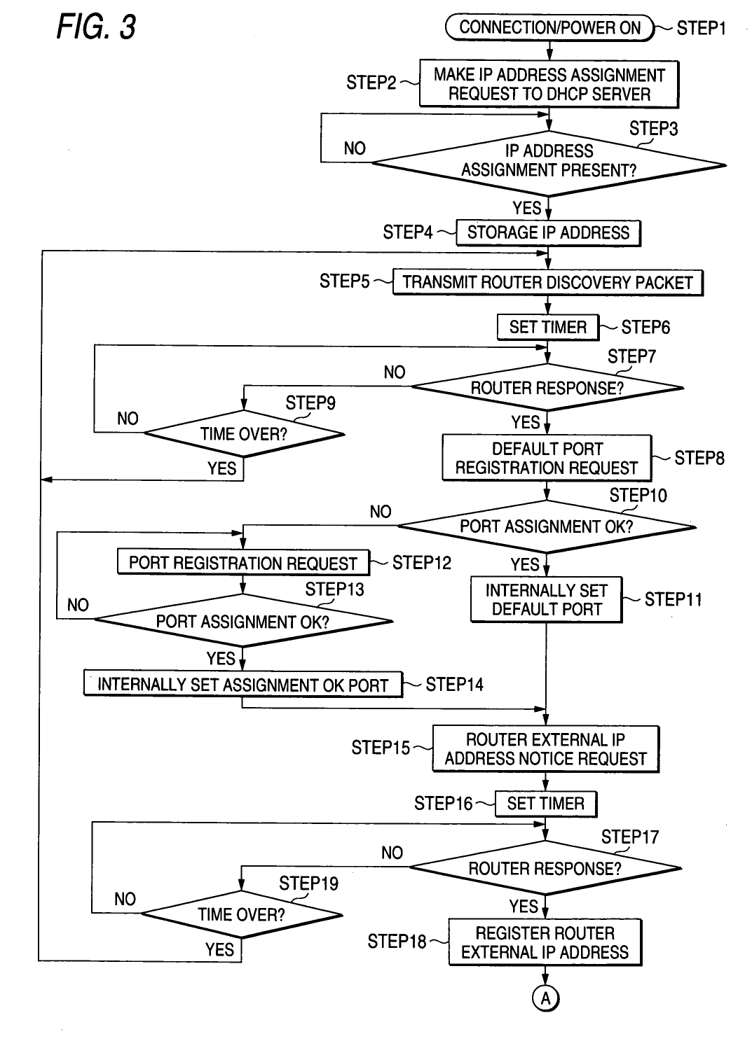

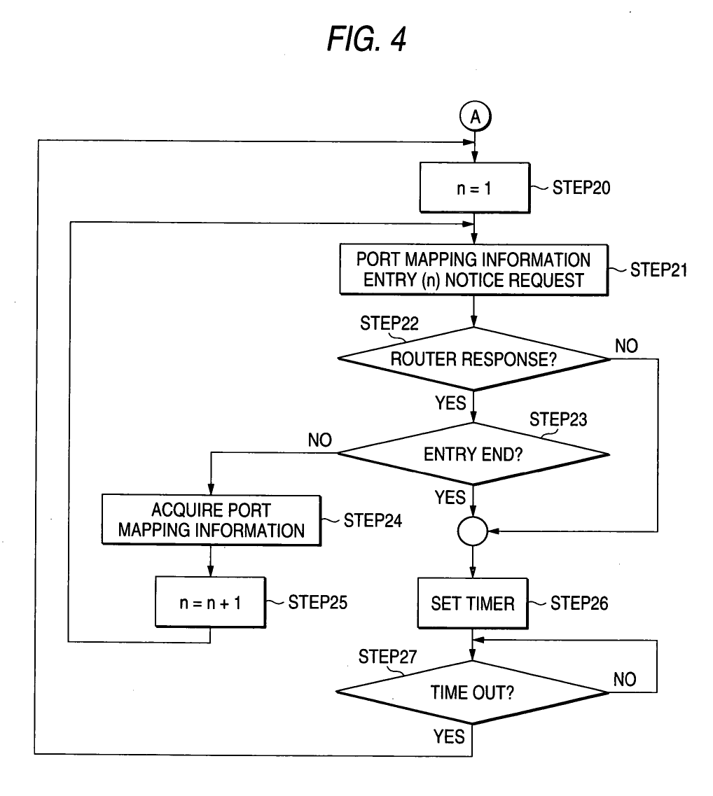

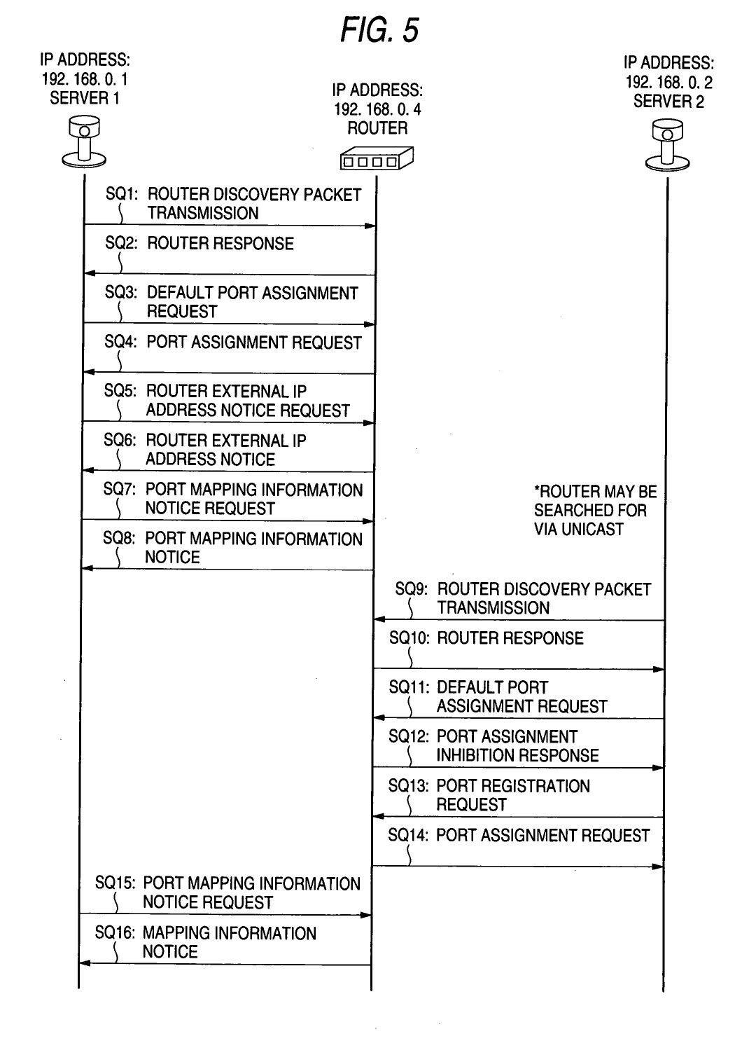

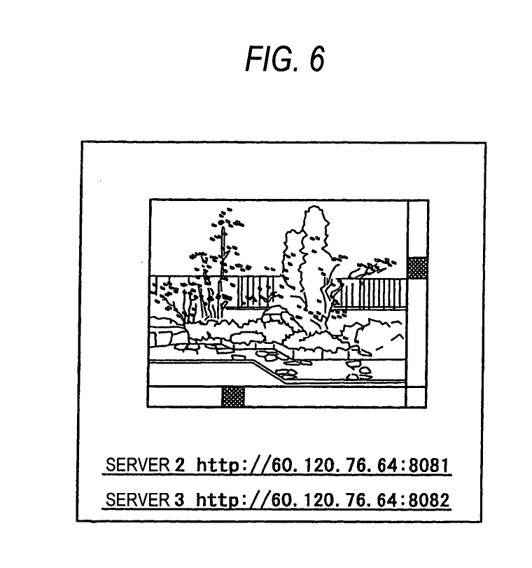

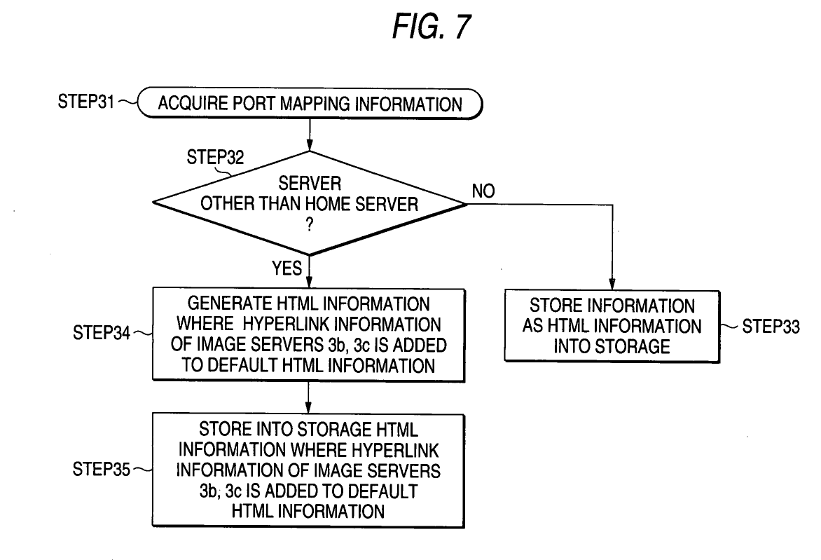

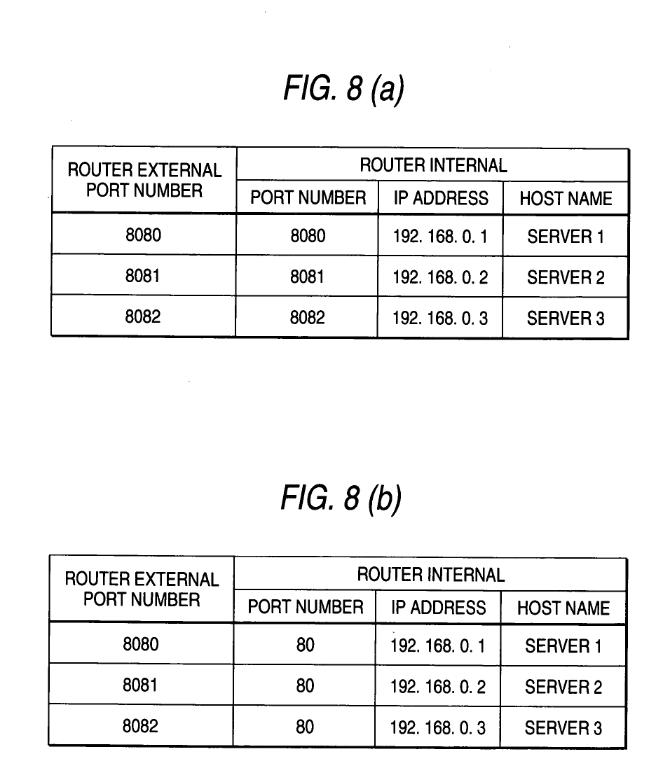

The servers subordinate to a router in Embodiment 1 will be described. FIG. 1 is a block diagram of a network system which accesses the servers subordinate to a router in Embodiment 1 of the invention. FIG. 2 is a block diagram of a server in Embodiment 1 of the invention. FIG. 3 is a flowchart of setting the server ports in Embodiment 1 of the invention. FIG. 4 is a flowchart of acquisition of port mapping information by a representative server in Embodiment 1 of the invention. FIG. 5 explains the sequence of acquisition of port mapping information by a representative server in Embodiment 1 of the invention. FIG. 6 explains the operation screen for a representative server in Embodiment 1 of the invention. FIG. 7 is a flowchart of generation of HTML information displayed on a representative server in Embodiment 1 of the invention. FIG. 8A is a first port forwarding table diagram in Embodiment 1 of the invention. FIG. 8B is a second port forwarding table diagram in Embodiment 1 of the invention.

In FIG. 1, a numeral 1 represents the Internet (wide area network of the invention) and 2 a router as an example of a router according to the invention. The router 2 has an interface connectable to the Internet 1 and comprises a plurality of LAN ports. The router 2 has a feature to perform routing for its subordinate devices, or image servers 3a, 3b, 3c mentioned later, in particular to perform dynamic port forwarding of IP packets in accordance with the UPnP standard.

The numerals 3a, 3b, 3c are servers of the invention and in particular camera-equipped image servers. An external terminal 4 can connect to the Internet 1 to access the image servers 3a, 3b, 3c. To the LAN is connected a DHCP (Dynamic Host Configuration Protocol) server 6 which assigns IP addresses to the image servers from among the predetermined local IP address (hereinafter referred to IP addresses) in the LAN. A DNS (Domain Name System) server 6 connectable to the router 2 via the Internet 1 performs a service of providing the latest global IP address (hereinafter referred to as the external IP address) corresponding to the host name in case the external terminal 4 attempts to access the image servers 3a, 3b, 3c by using the host name.

In Embodiment 1, when the image servers 3a, 3b, 3c are connected to the router 2, each server requests port number assignment from the router 2 and registers an available port number. In this embodiment, when one of the plurality of image servers 3a, 3b, 3c for example the image server 3a requests port number assignment, in case the assignment request is the earliest (or in accordance with other priority order), the router 2 assigns a predetermined fixed port number, for example “8080” on the Internet 1. By way of the port forward feature of the router 2, it is possible to recognize the image server 3a having at least the fixed port number “8080” from the Internet 1. In an access from the Internet 1, it is ensured that the image server 3a among the image servers 3a, 3b, 3c is accessible the image server 3a assigned the fixed port number “8080” establishes itself as a representative server and manages the port numbers used by the remaining image servers 3b, 3c.

When the other image servers 3b, 3c issues an assignment request to the router 2, the router 2 sequentially assigns ports to the image servers 3b, 3c. Having finished assigning ports to the image servers, the router 2 notifies port numbers assigned to the image servers 3b, 3c in response to a regular inquiry from the representative image server 3a. When the user wishes to access the image servers 3b, 3c from the terminal 4 via the Internet 1, the user has only to access the image server 3a from the terminal 4. This allows the image server 3a to provide its port number as address information by way of a web page provided by the image server to the terminal 4, thereby allowing connection to the image servers 3b, 3c. In this practice, assigning host names for identification to the image servers 3a, 3b, 3c facilitates connection via the user interface of the image server 3a.

Next, the internal configuration of the image servers 3a, 3b, 3c of Embodiment 1 is described referring to FIG. 2. In FIG. 2, an image server (for example the image server 3a) has a network interface 11 for communicating information with other terminals via the Internet 1. In order to issue a request from the browser on the terminal 4 to the image server 3a via the network interface 11 and display the web page obtained from the image server 3a, a file described in a markup language such as HTML is transmitted to the Internet 1.

The image server 3a comprises a camera 12. The image server 3a further comprises an image data generator 12 for processing R, G, B signals or a complementary color signal as a picture signal from a CCD or a CMOS image pickup device provided on the camera 12, generating a luminance signal Y and color difference signals Cr, Cb and compressing the resulting signal in the JPEG format, MPEG format or other compression formats.

The image server 3a further comprises a storage 14 for storing control programs and various data. In particular, a numeral 14a represents an HTML storage for storing a plurality of files where a display instruction and link information are described in a markup language such as HTML, 14b an image storage for storing image data compressed by the image data generator 13, 14c a port mapping storage for storing port mapping information described later, and 14d a router external address storage for storing the external IP address of the router 2 to which the image servers 3a, 3b, 3c are connected.

The image server 3a further comprises a web server section 15 for communicating with the Internet 1 by using the protocol TCP/IP and an HTML generator 16 for fetching a file described in a markup language such as HTML and transmitting the file to the browser of the external terminal 4 in response to an access to the web server section 15 from the browser.

A controller 17 is implemented as feature implementation means for load control programs into a central processing unit (CPU) to provide various features. Port management means 17a of the controller 17 manages port mapping information on other image servers. The port management means 17a performs registration to the fixed port number “8080”. Once registration is complete, the port management means 17a acts as a representative server and manages the port numbers of other image servers.

The image server 3a comprises a drive section 18 including a motor for performing panning/tilting operation of the camera 12. A camera controller 18 drives the drive section 18.

The controller 17 processes a request from a browser and operates the HTML generator 16 to create a file for a web page, fetches from the storage image data to be transmitted to the browser, or specifies the operation mode of the camera controller 18 to operate the same. The other image servers 3b, 3c has a similar configuration.

Operation of the image servers 3a, 3b, 3c is described below. Referring to FIG. 3, operation of the image server 3a as a representative server or a server managed by the representative server is described. As shown in FIG. 3, when the image server 3a is connected to a LAN or powered ON (step 1), the port management means 17a transmits a DHCP discovery packet to request a DHCP server 5 to assign an IP address (step 2). This procedure is repeated until the DHCP server makes assignment. Assuming the host names of the image servers 3a, 3b, 3c are “server 1”, “server 2” and “server 3” respectively, in case the image server 3a is connected, an IP address “192.168.0.1” corresponding to “server 1” is acquired as shown in FIGS. 8A, 8B. When the assignment is made (step 3), the IP address is stored into the storage 14 (step 4).

Next, the image server 3a transmits a router discovery packet (step 5), sets the timer (step 6), and waits until a response is received from the router 2 (step 7). In case a response is received from the router 2, the image server 3a acquires the IP address “192.168.0.4” of the router 2 from the source address contained in the replay message and transmits a default port registration request to the router 2 (step 8). This is to request a representative server to assign a default fixed port number “8080” to the representative server. In step 7, the image server 3a waits for a response from the router 2. In case time-over takes place (step 9), execution returns to step 5, where the image server 3a transmits a router discovery packet to the router 2 again. FIG. 8A shows a case where a common port number is used for the Internet 1 and LAN. FIG. 8B shows a case where separate port numbers are used for the Internet 1 and the LAN. The same port number “80” is used throughout the LAN. This facilitates mort management in the LAN.

The router 2 transmits a port assignment response. The image server 3a checks whether the fixed port number “8080” is assigned (step 10). In case assignment is made, the image server 3a sets the fixed port number “8080” as its port number (step 11). In case assignment of the fixed port number “8080” is inhibited, the image server 3a transmits a port registration request for assignment of other port numbers (step 12). The image server 3a checks whether the other port numbers have been assigned (step 13). In case the assignment has been made, the image server 3a sets the port number as its port number (step 14).

When setting of its port number is over, the image server 3a issues a router external IP address notice request to the router 2 (step 15), sets the timer (step 16) and waits until a response is received from the router 2 (step 17). In case a response is received from the router 2, the image server 3a registers a router external address, for example http://60.120.76.64 (step 18). In step 17, the image server 3a waits for a response from the router 2. In case time-over takes place (step 19), execution returns to step 5, where the image server 3a transmits a router discovery packet to the router 2 again. In the above procedure, a port is set to the image server 3a as a representative server or a server managed by the representative server. This registers at least one image server as a representative server. Any URL which can access the router 2 from the wide area network, including a router IP address and a domain name may be used. Instead of registering a router external IP address, a domain name (for example http://Server1.com) may be requested from the router 2 for registration.

A procedure for acquisition of port mapping information by the image server 3a registered as a representative server is described below referring to FIG. 4. This procedure uses the Get Generic Port Mapping Entry action is defined in the UPnP standard called IGD (Internet Gateway Device) DCP (Device Control Protocol). The image server 3a checks the servers in the LAN entered based on a port registration request by the port management means 17a in order to manage the image servers 3b, 3c subordinate to the router 2. Counting from the entry number n=1 (step 20), the image server 3a transmits a port mapping entry notice request to the router 2 (step 22). The image server 3a receives a port mapping entry notice from the router 2 and register the notice as port mapping information (step 24) until the router 2 no longer responds or the entry is complete, and increments the entry count by n (n=n+1) and starts with step 21 again to repeat the procedure.

When the router 2 no longer responds or the entry is complete, the image server 3a sets the timer (step 26). On a time-out, (step 27), execution returns to step 20. This means that the image server 3a acquires port mapping information on a regular basis.

When the image servers 3b, 3c are assigned their port numbers, the image servers 3b, 3c may respectively notify the image server 3a as a representative server of the port numbers. In case the image server 3a periodically acquires port mapping, a delay is inevitable until the image servers 3b, 3c are port-mapped. In case the image servers 3b, 3c have notified their port numbers, port registration is made immediately so as to minimize the inaccessible condition of the image servers 3b, 3c.

The port setting procedure and the procedure for port mapping information acquisition by a representative server mentioned above are described using a sequence chart shown in FIG. 5. As shown in FIG. 5, the image server 3a transmits a router discovery packet (SQ1) When the router 2 responds (SQ2), the image server 3a transmits a default port registration request (SQ3). Receiving the default port registration request, the router 2 transmits a port assignment response (SQ4). The image server 3a makes a router external IP address notice request (SQ5). The router 2 notifies a router external IP address (SQ6). The image server 3a issues a first port mapping information notice request of the regular port mapping information notice request procedure to the router 2 (SQ7). The router 2 transmits a first port mapping information notice (SQ8).

Next, the image server 3b is connected to a LAN and transmits a router discovery packet (SQ9). When the router 2 responds (SQ10), the image server 3a transmits a default port registration request to the router 2 (SQ11). Receiving the default port registration request, the router 2 transmits a port assignment inhibition response (SQ12) because the fixed port number is assigned to the image server 3a. The image server 3a makes a port registration request again by way of a separate port number (SQ13). The router 2 transmits a port assignment permission response (SQ14) in case the requested port number is not in use.

After that, the image server 3a periodically issues a second, a third port mapping information notice request and so on (SQ15) to the router 2. The router 2 transmits a second, a third port mapping information notice and so on (SQ16). This allows the port mapping information to be managed by the image server 3a. An access from an external terminal 4 to the port number of the image server 3a can recognize the port numbers of the remaining image servers 3b, 3c.

Thus, in case the image server 3a is accessed by the terminal as a client via the Internet 1, the image server 3a can be linked as a representative server to the image servers 3b, 3c. As shown in FIG. 6, on the user interface on a web page provided by the representative server to the terminal 4 are displayed the host name “server 2” and the external IP address http://60.120.76.64.8081 of the image server 3b in a linkable fashion. The host name “server 3” and the external IP address http://60.120.76.64.8082 of the image server 3c are also displayed in a linkable fashion. The host names “server 1”, “server 2” and “server 3” are identification information for identifying the image servers 3a, 3b, 3c which is stored into a port forward table together with port information for easy identification of image servers. More simply, only a host name may be used as a link destination. A domain name may be used instead of an external IP address (for example http://myRouter.com.8081).

A web page displayed on the image server 3a is created by the HTML generator 16 and stored into the HTML storage 14a. The web page generation procedure is described below. In FIG. 7, the image server 3a acquires port mapping information (step 31) and checks whether other image servers 3b, 3c are present (step 32). In case the image servers 3b, 3c are absent, the image server 3a stores the default HTML information without hyperlink information shown in FIG. 6 into the HTML storage 14a.

In case the image servers 3b, 3c are present, the image server 3a generates HTML information where the hyperlink information of the image servers 3b, 3c is added to the default HTML information (step 34). The image server 3a then stores the HTML information including the hyperlink information into the HTML storage 14a. In this way, a web page presented from the image server 3a to the terminal 4 is stored into the HTML storage 14a when the LAN includes the image server 3a alone as well as when the image servers 3b, 3c are connected to the LAN. The web page is made accessible to the terminal 4 as an external client. Note that hyperlink information is added by using the external network address (global IP address or domain name) of the router 1 where the port numbers of the image servers 3b, 3c are added as shown in FIG. 6. The server names of the image servers 3b, 3c are displayed in the procedure of addition so that the user of the terminal 4 can readily check the link destination information. The server names are “server 1”, “server 2” and so on which are automatically assigned by the HTML generator 16 for easy identification. Remote operation from the terminal 4 may be used to instruct a server name. In this case, the image server 3a receives the server name change instruction and the HTML generator 16 changes the server name. It is also allowed to follow the link to the servers 3b, 3C and change a desired server name on the screen for setting the servers 3b, 3c and display the new server name by receiving the update information on the server 3a and regenerating the new server name on the HTML generator 16.

A procedure for accessing from the terminal 4 is described. The image server 3a as a representative server waits for an access from the terminal 4. When an access is made, the image server 3a transmits the HTML information stored in the HTML storage 14a to the terminal 4. When an access is made to the image servers 3b, 3c from the web page displayed, the hyperlink information added to the HTML information of the user interface is used to access the external IP address “http://60.120.76.64.8081” or “h “http://60.120.76.64.8082” respectively. Port forwarding is made in the router 2.

When the web page in FIG. 6 transmitted from the image servers 3a, 3b, 3c is displayed on the browser screen, the terminal 4 makes a request to the image servers for images. In response to this request, the image servers 3a, 3b, 3c reads the data of the image shot with the camera 12 from the image storage 14b and transmits the image data to the terminal 4. In this procedure, the terminal 4 as a client connected to the Internet 1 can acquire image data from the image servers 3a, 3b, 3c by using the image server 3a as a representative server.

In this way, the user on the Internet must know the port numbers of the image servers 3a, 3b, 3c on the LAN in Embodiment 1. A representative server which is assigned a fixed port number acquires the global IP address of the router 2 and port mapping information on other servers in order to manage the address information on the other servers. This makes it possible to make an access from the Internet 1 without knowing all of the port numbers of the image servers 3a, 3b, 3c.

### Embodiment 2

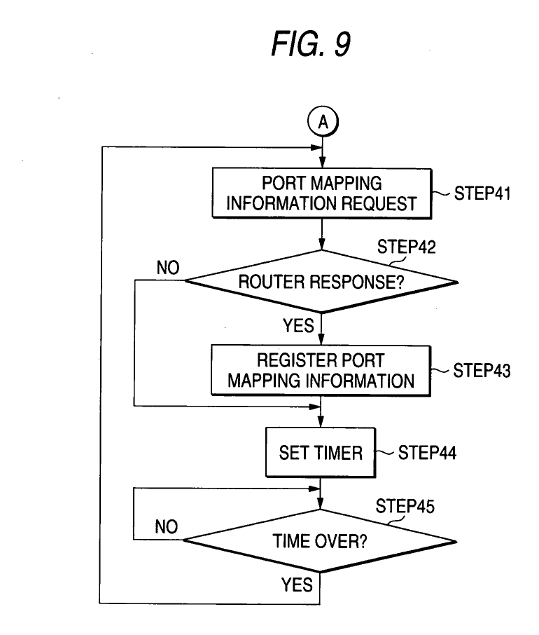

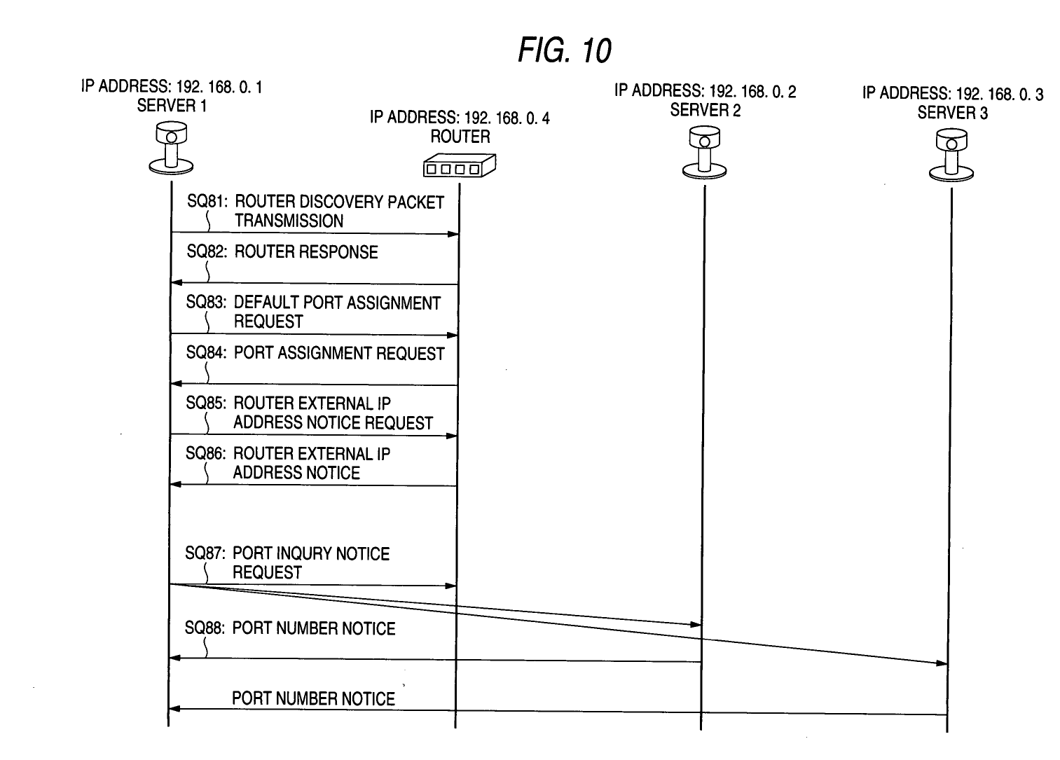

A server which manages port mapping information in Embodiment 2 is described below. Among a plurality of image servers connected to a router, the image server 3a as a representative server periodically makes an inquiry about the port number of the other servers 3b, 3c to the servers 3b, 3c. FIG. 9 is a flowchart of acquisition of port mapping information by a representative server in Embodiment 2 of the invention. FIG. 10 explains the sequence of acquisition of port mapping information by a representative server in Embodiment 2 of the invention. The port setting chart of FIG. 3 is referenced also in Embodiment 2.

The flowchart of setting the ports of image servers in Embodiment 2 is the same as that in Embodiment 1 from step 1 to step 19. As shown in FIG. 3, when the image server 3a is powered ON (step 1), the port management means 17a transmits a DHCP discovery packet to request a DHCP server 5 to assign an IP address (step 2). When the assignment is made (step 3), the IP address is stored into the storage 14 (step 4). Next, the image server 3a transmits a router discovery packet (step 5), sets the timer (step 6), and waits until a response is received from the router 2 (step 7). In case a response is received from the router 2, the image server 3a transmits a default port registration request to the router 2 (step 8). In case time-over takes place (step 9) in step 7, execution returns to step 5, where the image server 3a transmits a router discovery packet to the router 2 again. The router 2 transmits aport assignment response. The image server 3a checks whether the fixed port number is assigned (step 10). In case assignment is made, the image server 3a sets the fixed port number as its port number (step 11). In case assignment of the fixed port number is inhibited, the image server 3a transmits a port registration request for assignment of other port numbers (step 12). The image server 3a checks whether the other port numbers have been assigned (step 13). In case the assignment has been made, the image server 3a sets the port number as its port number (step 14).

When setting of its port number is over, the image server 3a issues a router external IP address notice request to the router 2 (step 15), sets the timer (step 16) and waits until a response is received from the router 2 (step 17). In case a response is received from the router 2, the image server 3a registers a router external address (step 18). In case time-over takes place (step 19), execution returns to step 5, where the image server 3a transmits a router discovery packet to the router 2 again. In the above procedure, a port is set to the image server 3a as a representative server or a server managed by the representative server.

A procedure for acquisition of port mapping information by the image server 3a registered as a representative server is described below referring to FIG. 9. The image server 3a issues a port mapping information notice request to the image servers 3b, 3c in order to manage the image servers 3b, 3c subordinate to the router 2 (step 41). The port mapping information notice request is made via broadcast or multicast. Present/Absence of a response is checked (step 42). In case a response is made, port mapping information is registered (step 44) and the timer is set (step 44). Also in case no response is received in step 42, the timer is set in step 44. When a time-over takes place (step 45), execution returns to step 41, where the image server 3a issues a port mapping information notice request to the image servers 3b, 3c. By repeating this procedure, the image server 3a can periodically acquire port mapping information.

FIG. 10 shows the port mapping sequence. SQ81 through SQ86 is a sequence corresponding to steps 1 through 19 mentioned above and is the same as SQ1 through SQ6 in Embodiment 1. Fore details of the sequence, refer to Embodiment 1.

Having acquired a router external IP address, the image server 3a issues a port mapping information notice request (SQ87) In response to this, the image servers 3b, 3c notify the image server 3a of their respective port numbers (SQ88). The image server 3a retains the port numbers of the other image servers 3b, 3c. While port mapping information notice request is made periodically at predetermined intervals, the same effect is obtained by making the port mapping information notice request at random time intervals within a predetermined range.

In this way, the user on the Internet must know the port numbers of the image servers 3a, 3b, 3c on the LAN in Embodiment 1. A representative server which is assigned a fixed port number acquires the global IP address of the router 2 and port mapping information on other servers by making an inquiry to the router 2 and their image servers in order to manage the address information on the other image servers. This makes it possible to make an access from the Internet 1 without knowing all of the port numbers of the image servers 3a, 3b, 3c.

Port mapping information may be transmitted from the router or other servers via broadcast, multicast or unicast without the representative server making an inquiry, and the representative server may receive the transmit data to acquire the port mapping information.

### Embodiment 3

An image server in Embodiment 1 described above periodically makes an inquiry to the router 2 about port mapping information. The image server 3a in Embodiment 2 issues a port mapping information batch notice request to the image servers 3b, 3c. An image server in Embodiment 3 does not make an inquiry about port mapping information but directly fetches a mapping table of use registration information registered to the router 2 and determines the registration entries of the image servers 3b, 3c from this table.

The Get Generic Port Mapping Entry action is defined in the UPnP standard called IGD (Internet Gateway Device) DCP (Device Control Protocol). In the mapping table of use registration information set to the router 2 are stored the IP addresses, internal port numbers and comment statements of the servers 3a, 3b, 3c in correspondence to the external port number of the router 2. The character strings “server 2” and “server 3” as the host names of the image servers 3b, 3c are retrieved from the comment statements in order to acquire port mapping information. In case other server information from which port mapping information need not be acquired is stored in the mapping table, information on the servers having specific information included in the comment statements is to be acquired. Including for example commodity names and model names as specific information readily selects a specific server.

In this way, an image server in Embodiment 3 does not make an inquiry about port mapping information but directly fetches a mapping table of use registration information registered to the router 2 and determines the registration entries of the image servers 3b, 3c from this table. This readily acquires port mapping information.

### Embodiment 4

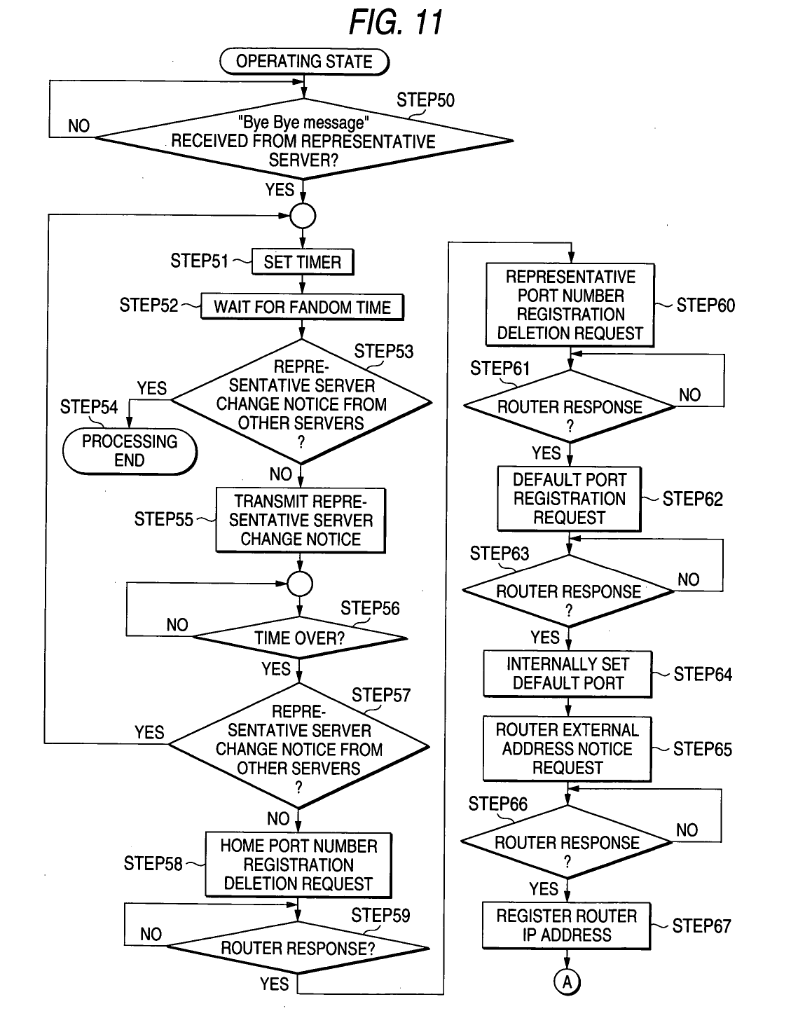

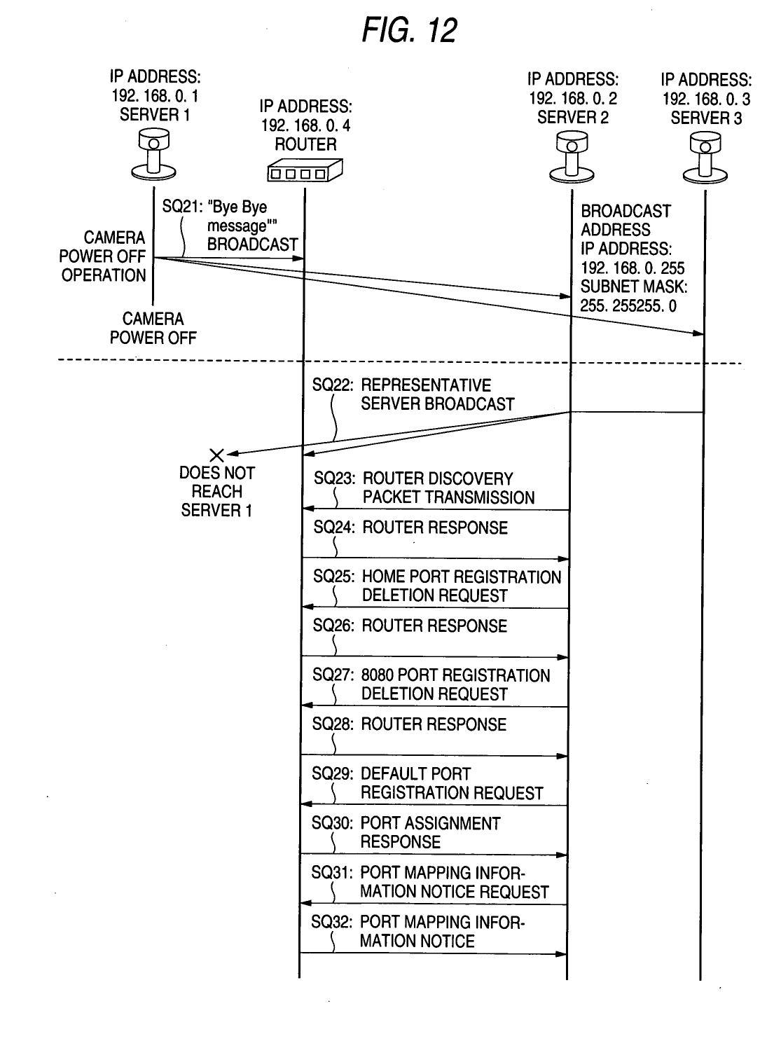

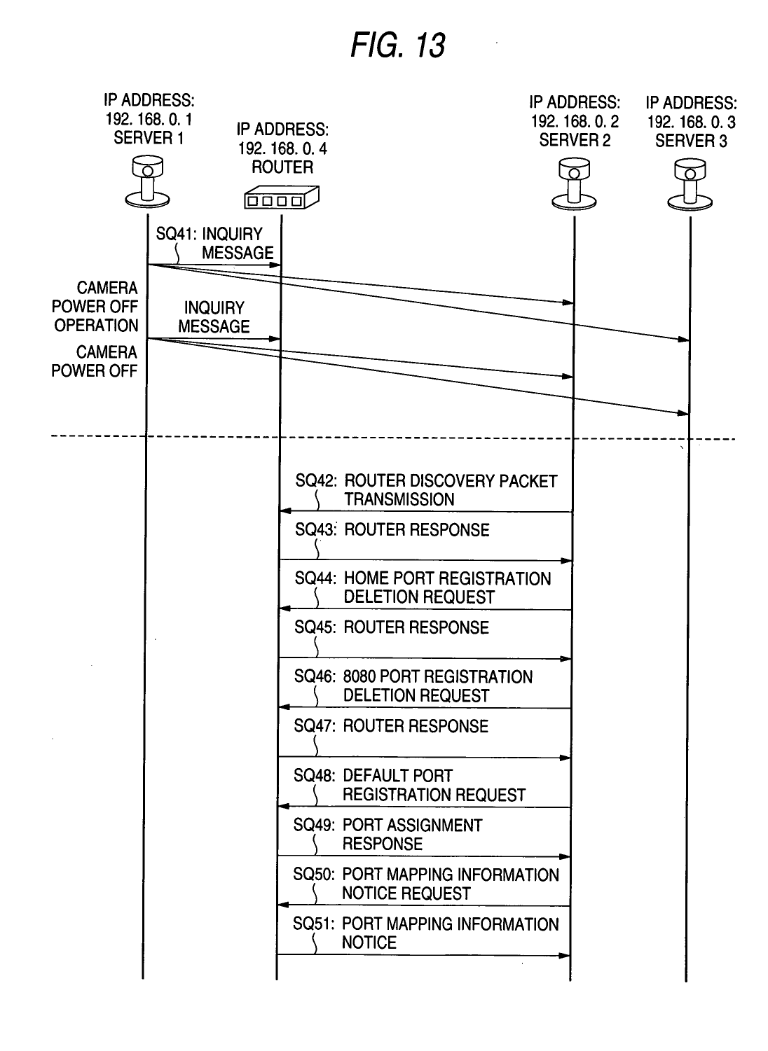

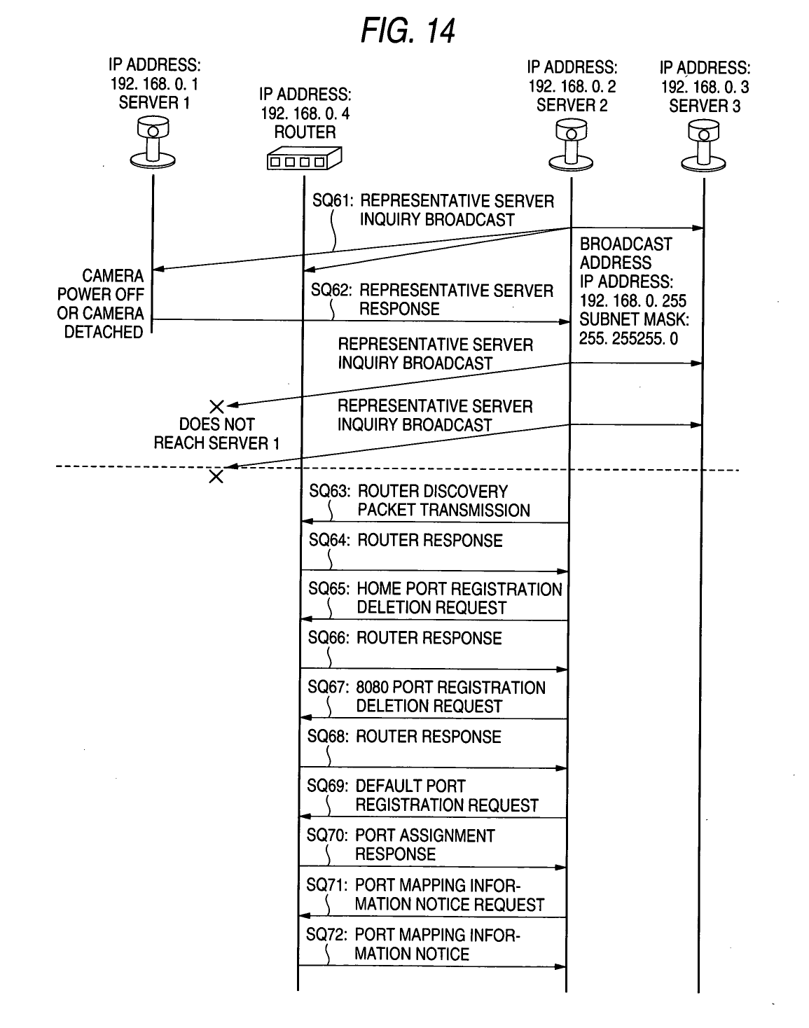

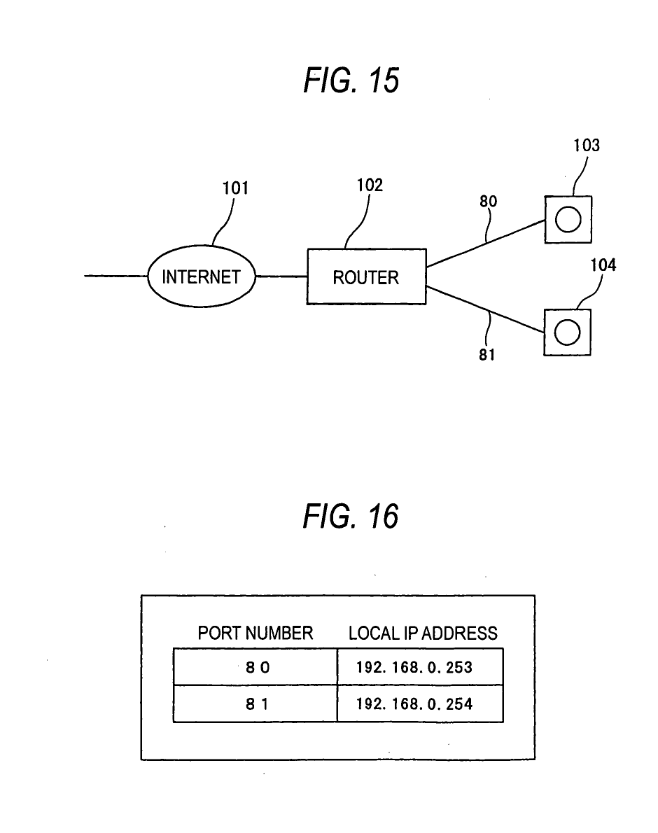

An access to each of the image servers 3a, 3b, 3c in Embodiments 1 through 3 is allowed only in the presence of a representative server. Thus, an access from outside a LAN is disabled when the representative server is powered OFF. Thus, it is necessary for another server to take over a representative server in case the representative server has withdrawn from the LAN. In Embodiment 4, the representative server is detected and alternated among the image servers. Operation of each server is described below. FIG. 11 is a flowchart of rotation of a representative server in Embodiment 4 of the invention. FIG. 12 explains a first rotation sequence of a representative server in Embodiment 4 of the invention. FIG. 13 explains a second rotation sequence of a representative server in Embodiment 4 of the invention. FIG. 14 explains a third rotation sequence of a representative server in Embodiment 4 of the invention.

When the image server 3a as a representative server is powered OFF while the image servers 3a, 3b, 3c subordinate to the router is operating, the port management means 17a transmits a withdrawal notice message (Bye Bye Message) to the effect that the image server 3a is going to leave (step 50) in the first rotation sequence. The image servers 3b, 3c receive this message and set the timer (step 51), calculates the random times and wait for respective random times (step 52). It is checked whether a representative server rotation notice has been received from another server to the effect that the random time has elapsed earlier and the other server has become a new representative server (step 53). In case the representative server rotation notice has been received, the processing is complete (step 54). Instead of the random time, each of the image servers 3b, 3c may transmit an identification message after a time calculated from a server-specific value has elapsed and a server determined based on a preset determination rule may inherit the position of a representative server. The representative server is rotated by using a server-specific value and based on a preset determination rule, thus smoothly rotating the position of a representative server.

In case the representative server rotation notice has not been received, the server itself transmits a representative server rotation notice (step 55). The server waits until a predetermined time elapses, and on a time-over (step 56), it is checked whether a representative server rotation notice has been received from another server. In case the representative server rotation notice has been received, this means a racing between the representative server rotation notices. Execution then returns to step 51, where the representative server setting is repeated.

In case the representative server rotation notice has not been received from another server, the server itself transmits a home port number registration deletion request to the router 2 (step 58). When a response is received from the router 2 (step 59), the server transmits a representative server port number registration deletion request in order to delete the fixed port number “8080” registered to the image server 3a (step 60). When a response is received from the router 2 (step 61), the server itself makes a request for registration of the fixed port number “8080” in order to become a representative server (step 62). When a response is received from the router 2 (step 63), the server internally sets the fixed port number “8080”.

Next, the server transmits as a representative server a router external IP address notice request to the router 2 (step 65). When a response is received from the router 2 (step 61), the server registers the router external IP address received (step 67). After that, port mapping shown in FIGS. 4 and 9 takes place.

The first rotation sequence mentioned above will be described referring to FIG. 12. The image server 3a transmits via broadcast a withdrawal notice message (Bye Bye Message) to the effect that the image server 3a is going to leave (SQ21) The image server 3a may transmit the message via multicast or unicast to all the other servers 3b, 3c and the router 2. Each of the image servers 3b, 3c which received the message waits for a random time. The image server 3b whose random time has elapsed earlier broadcasts an identification message to the effect that it is going to be a representative server (SQ22). The message may be transmitted via multicast or unicast. On receipt of the identification message, the image server transmits a router discovery packet throughout the LAN (SQ23). When the router responds to the packet (SQ24), the image server 3b makes a home port number registration deletion request in order to acquire the fixed port number “8080” (SQ25). When a response is received from the router 2 (SQ26), the image server 3b makes a request for deletion of the fixed port number “8080” registered to the image server 3a (SQ27). When a response is received from the router 2 (SQ28), the image server 3b makes a default port registration request (SQ29). When the router 2 makes a port assignment (SQ30), the image server 3b makes a port mapping information notice request (SQ31) and the router 2 transmits a port mapping information notice (SQ32).

In this way, the image server 3b which has transmitted an identification message earliest after the powered-OFF image server 3a transmitted a withdrawal message is registered as a representative server. When a representative server is absent, an access from outside the LAN is disabled but the representative server is inherited so that an access from outside the LAN is virtually uninterrupted.

Next, the second rotation sequence in FIG. 13 will be described. The image server 3a as a representative server periodically makes a port number inquiry. When the image server 3a is powered OFF, the periodical inquiry message is not transmitted. This causes other image servers 3b, 3c to detect absence of a representative server and proceed to rotation of a representative server.

The image server 3a periodically transmits an inquiry message to acquire the port numbers of the other image servers 3b, 3c and the router 2 (SQ41) In this state, when an inquiry message is not received from the current representative server at least twice in a row, the image servers 3b, 3c and the router 2 assume absence of a representative server. The first failure to deliver the inquiry message maybe caused by a loss of packets so that the second failure is used to trigger the determination of the absence of a representative server in order to avoid a detection error. To further prevent a possible detection error, absence of a representative server may be assumed after the inquiry message is not received at least three times in a row.

In the second rotation sequence, the position of a representative server is rotated in the order of the port numbers in FIGS. 8A and 8B. Setting has been made to rotate the position of a representative server in the order of “8080”, “8081” and “8082”. In case the image server 3a is powered OFF and it is assumed that a representative server is absent, the image server 3b with the port number “8081” performs the following sequence in order to become a representative server. In case the image server 3b is also powered OFF at the same time with the image server 3a, the image server 3c with the port number “8082” assumes absence of a representative server after the time necessary for the image server 3b with the port number “8081” to perform operation to become a representative server, and starts operation to become a representative server.

The image server 3b transmits a router discovery packet throughout the LAN (SQ42). When the router responds to the packet (SQ43), the image server 3b transmits a home port number registration deletion request (SQ44). When a response is received from the router 2 (SQ45), the image server 3b makes a request for deletion of the fixed port number “8080” registered to the image server 3a (SQ46). When a response is received from the router 2 (SQ47), the image server 3b makes a default port registration request (SQ48). When the router 2 makes a port assignment (SQ49), the image server 3b makes a port mapping information notice request (SQ50) and the router 2 transmits a port mapping information notice (SQ51).

Thus, when the image server 3a is powered OFF and an inquiry message from the representative server is no longer received, the image server 3b with the next port number “8081” is registered to a representative server. When a representative server is absent, an access from outside the LAN is disabled but the representative server is inherited so that an access from outside the LAN is virtually uninterrupted.

Next, the third rotation sequence in FIG. 14 will be described. All of the image servers 3b, 3c periodically communicate with the image server 3a as a representative server, such as notifies a port number, and detects absence of a representative server when a response is not received from the representative server. When an inquiry message is not received from the current representative server at least twice in a row, the image servers 3b, 3c and the router 2 assume absence of a representative server in order to avoid a detection error due to a loss of packets. Each of the image servers 3b, 3c makes an inquiry to the representative server at random intervals via broadcast, multicast or unicast. The IP address of a representative server necessary for a unicast inquiry is obtained by way of a notice from the representative server or by acquiring the port mapping table of the router. Same as the second rotation sequence, the position of a representative server is rotated in the order of port numbers, so that the router 2 is inquired about which image server will become a representative server. In case it is assumed that a representative server is absent, the image server 3b with the port number “8081” performs the following rotation sequence in accordance with its precedence.

Each image server 3b or 3c transmits via broadcast a representative server inquiry message in order at random intervals (SQ61). The image server 3a as a representative server returns a representative server response (SQ62). In case the broadcast representative server inquiry message is not responded at least twice in a row, the image server 3b with the port number “8081” transmits a router discovery packet throughout the LAN (SQ63). When the router responds to the packet (SQ64), the image server 3b transmits a home port number registration deletion request (SQ65). When a response is received from the router 2 (SQ66), the image server 3b makes a request for deletion of the fixed port number “8080” registered to the image server 3a (SQ67). When a response is received from the router 2 (SQ68), the image server 3b makes a default port registration request (SQ69). When the router 2 makes a port assignment (SQ70), the image server 3b makes aport mapping information notice request (SQ71) and the router 2 transmits a port mapping information notice (SQ51).

Thus, when the image server 3a is powered OFF and an inquiry message from the representative server is no longer received, the image server 3b with the next port number “8081” is registered to a representative server. When a representative server is absent, an access from outside the LAN is disabled but the representative server is inherited so that an access from outside the LAN is virtually uninterrupted.

In this way, an image server in Embodiment 4 gives a fixed port number to one of the plurality of image servers connected to the router. The router assumes this server as a representative server as performs port forwarding. The representative server manages the port numbers of the other servers. It is thus possible to access other servers by using the hyperlink information on a web page by accessing a representative server via the Internet from outside.

While the server 3 automatically performs port assignment request to the router 2 after power ON in Embodiments 1 through 4, the server 3 may be equipped with a switch (a hardware switch as well as a software switch) and port assignment request may be made when the switch is turned ON.

While the embodiments of the invention have been classified into Embodiments 1 through 4 for convenience, a server according to a combination of a plurality of embodiments, such as one operating in accordance with a combination of part of Embodiment 1 and part of Embodiment 4 or a combination of part of Embodiment 1 and part of Embodiment 2 is included in the invention.

As mentioned hereinabove, according to a server of the invention, when port management means is assigned a fixed port number, the server thereby obtains the position of a representative server and acquires the global IP address of a relay device and port mapping information as well as manages the address information of other servers. In an access from a wide area network, the accessing terminal is first connected to a representative server and acquires the address/port information on other servers to access the other servers.

A plurality of image servers comprising for example a camera and an image data generator for processing a picture signal of a picture shot with the camera to encode the signal are individually accessible with a single IP address even in case they are arranged under a relay device (router). While it is difficult to assign individual IP addresses to image servers in the current situation where the IP protocol IPv4 is mainly used, a single IP address assigned to a relay device maybe sufficient for an access to an individual server by using the address/port information on other servers.

### CROSS REFERENCE TO RELATED APPLICATION

This application is based upon and claims the benefit of priority of Japanese Patent Application No2003-012241 filed on Jan. 21, 2003, the contents of which are incorporated herein by reference in its entirety.

1. A server, which is subordinate to a relay device having a port forwarding feature, comprising:
a port management means, which requests the relay device to assign a predetermined port number for a representative server and which is assigned a port number by the relay device,
wherein the port management means acquires the wide area network address of the relay device and port mapping information in case the port management means is registered to the predetermined port address and,
further wherein the port management means provides the address/port information on other servers in response to an access from a wide area network.

2. The server according to claim 1, wherein when a request is issued to the relay device,
in case the predetermined number is unregistered, the port management means is assigned the predetermined port number,
in case the predetermined port number is registered, the port management means is assigned another port number.

3. The server according to claim 1, wherein
in case it is assigned to the predetermined port number, said port management means periodically requests port mapping information.

4. A server, which is subordinate to a relay device having a port forwarding feature, comprising:
a port management means, which requests a relay device to assign a predetermined port number for a representative server and which is assigned a port number by the relay device,
wherein the port management means makes a port-mapping inquiry to other servers subordinate to the relay device in case the port management means is registered to the predetermined port number and retains the port numbers transmitted from the other servers, and
further wherein on an access from a wide area network, the port management means provides the information on the port numbers of the other servers.

5. The server according to claim 4, wherein
the port management means makes an inquiry via broadcast, multicast or unicast to all servers.

6. The server according to claim 1, wherein
in case the server is assigned a predetermined port number, the port management means requests use registration information from the relay device and fetches port mapping information from the use registration information.

7. The server according to claim 1, wherein
in case the server is assigned a predetermined port number, the port management means notifies the other server of its port number assigned.

8. The server according to any one of claims 1 through 7, further comprising:
a web page generating section and generating a web page where address information on other servers is attached in a linkable fashion.

9. The server according to any one of claims 1 through 8, wherein the port management means adds host names for identification to other servers and posts the host names in the address information.

10. The server according to any one of claims 1 through 9, wherein
when the server has detected that a server registered to a predetermined port number withdrew from the LAN, another server transmits an identification message to register itself to the predetermined port.

11. The server according to claim 10, wherein other servers transmit identification messages after a random time has elapsed and, in case two or more servers issue identification message within a certain time after that, these servers transmit identification messages respectively after a random time has elapsed until a sole server which identifies itself uses the predetermined port number.

12. The server according to any one of claims 1 through 9, wherein
after detection of withdrawal, another server is registered to the predetermined port based on the mapped port numbers.

13. The server according to claim 10, wherein
after detection of withdrawal, other servers respectively transmit identification messages after a time calculated from each server-specific value has elapsed and a sole server determined based on a predetermined determination rule becomes a representative server and is registered to said predetermined port.

14. The server according to any one of claims 10 through 13, wherein
a server registered to a predetermined port number communicates as a single unit a withdrawal notice message to the servers in the LAN to notify that the server has withdrawn from the LAN.

15. The server according to any one of claims 10 through 13, wherein
a server in the LAN detects that there is no inquiry about port mapping information from the server registered to a predetermined port number to detect that the server has withdrawn from the LAN.

16. The server according to any one of claims 10 through 13, wherein
all servers in the LAN make inquiries to the server registered to a predetermined port number about its presence and receiving no response, detects the server has withdrawn from the LAN.

17. The server according to any one of claims 1 through 16, further comprising:
a camera,
an image data generator, which processes a picture signal of a picture shot with the camera to encode the signal, and
a web server section, which transmits the image data to a wide area network, wherein the server transmits a photographed image as an image server.

18. A server connected to a second network of a relay device which transfers packets from its first network to its second network in accordance with a destination port number,
wherein the server requests the relay device to assign a predetermined port number out of the port numbers used for data transfer, and determining that the predetermined port number has been assigned, acquires the port assignment information on other servers from the relay device to generate display information including the port Assignment information and transmit the display information in response to an access from the first network via the relay device.

19. The server according to any one of claims 1 through 18, wherein the server requests assignment of a predetermined port number used for the transfer and address information on the first network of the relay device from the relay device.

20. The server according to claim 18 or 19, wherein the server periodically acquires the port assignment information.
